(19) United States
(12) Patent Application Publication
(10) Pub. No.: US 2011/0082688 A1
(43) Pub. Date: Apr. 7, 2011

(54) Apparatus and Method for Analyzing Intention

(75) Inventors: Jung-Eun KIM, Yongin-si (KR); Jeong-Mi CHO, Seongnam-si (KR)

(73) Assignee: Samsung Electronics Co., Ltd., Suwon-si (KR)

(21) Appl. No.: 12/894,846

(22) Filed: Sep. 30, 2010

(30) Foreign Application Priority Data
Oct. 1, 2009 (KR) 10-2009-0094019

(51) Int. Cl. G06F 17/27

(52) U.S. Cl. 704/9

(57) ABSTRACT

An apparatus and system for analyzing intention are provided. The apparatus for analyzing an intention applies a context-free grammar to each of one or more sentences in units of one or more phrases to perform phrase spotting on each sentence, thereby extending a recognition range for an out-of-grammar (OOG) expression. Meanwhile, the apparatus for analyzing an intention determines whether sentences that have undergone phrase spotting are grammatically valid by applying a dependency grammar to the sentences to filter an invalid sentence, and generates the intention analysis result of a valid sentence, thereby and grammatically and/or semantically verifying a sentence that has undergone speech recognition while extending a speech recognition range.

### CROSS-REFERENCE TO RELATED APPLICATION(S)

This application claims the benefit under 35 U.S.C. §119(a) of Korean Patent Application No. 10-2009-0094019 filed on Oct. 1, 2009, the entire disclosure of which is incorporated herein by reference for all purposes.

### BACKGROUND

1. Field

The following description relates to a technology for analyzing the intention of a user, and more particularly, to an apparatus and method for analyzing the intention of a sentence generated by a user.

2. Description of the Related Art

Voice interaction technology is becoming essential for interaction between humans and computer systems. Modern voice recognition technology provides high performance for previously defined speeches.

Generally, to model a user's speech, a grammar-based language model such as context free grammar language model or a statistical language model such as an N-gram language model is used.

The grammar-based language model advantageously accepts only a grammatically and semantically correct sentence as a recognition result, but cannot recognize a sentence which has not been pre-defined in terms of grammars. The statistical language models may recognize some sentences that have not been pre-defined and do not require a user to manually define grammar.

However, because the statistical language model cannot take into consideration a structure of a whole sentence in the course of speech recognition, an ungrammatical sentence may be output as a recognition result. Also, a large amount of training data is needed to generate a language model. Due to these drawbacks, it is difficult to use the current speech dialogue system in a real-world application.

### SUMMARY

In one general aspect, there is provided an apparatus for analyzing intention, the apparatus comprising: a phrase spotter configured to perform phrase spotting on at least one sentence by applying a context-free grammar to the at least one sentence in units of words or phrases; a valid sentence determiner configured to: determine whether the at least one sentence is grammatically valid by applying a dependency grammar to the sentence that has undergone phrase spotting; and filter an invalid sentence; and an intention deducer configured to generate an intention analysis result of a sentence determined to be valid.

The apparatus may further include that the intention deducer is further configured to: select an intention frame to be the intention analysis result of the sentence determined to be valid; determine a semantic role value of at least one semantic role element included in the selected intention frame; and allocate the determined semantic role value to the semantic role element included in the selected intention frame.

The apparatus may further include that, in response to the intention deducer allocating the semantic role value, the intention deducer is further configured to: determine the semantic role value from the sentence determined to be valid through phrase chunking; and allocate the determined semantic role value to the semantic role element in the selected intention frame if at least one semantic role element of the sentence determined to be valid matches at least one semantic role element in the selected intention frame.

The apparatus may further include that, in response to the sentence determined to be valid comprising a semantic role element other than the at least one semantic role element in the intention frame, the intention deducer is further configured to: determine whether the other semantic intention role element can be replaced by the semantic role element in the intention frame using a role network; determine a semantic role value of the semantic role element in the intention frame from the sentence determined to be valid through phrase chunking in response to it being determined that the other semantic intention role element can be replaced by the semantic role element in the intention frame; and allocate the determined semantic role value to the semantic role element in the intention frame.

The apparatus may further include that the intention deducer is further configured to estimate the semantic role value of the at least one semantic role element in the intention frame using an ontology.

The apparatus may further include a scorer configured to: calculate a probability that intention analysis has been correctly performed on at least one intention analysis result candidate to which the semantic role value of the semantic role element included in the selected intention frame is allocated; and score the intention analysis result candidate.

The apparatus may further include an analysis applier configured to: apply the intention analysis result to an application; and generate an intention analysis application result.

The apparatus may further include a speech recognizer configured to convert an audio input into at least one sentence, the at least one sentence comprising an n-best sentence converted by the speech recognizer.

In another general aspect, there is provided a method of analyzing an intention, the method comprising: performing phrase spotting on at least one sentence by applying a context-free grammar to the at least one sentence in units of words or phrases; determining whether the at least one sentence is grammatically valid by: applying a dependency grammar to the sentence that has undergone phrase spotting; and filtering an invalid sentence; and generating an intention analysis result of a sentence determined to be valid.

The method may further include that the generating of the intention analysis result of the sentence determined to be valid comprises: selecting an intention frame to be the intention analysis result of the sentence determined to be valid; determining semantic role values of semantic role elements included in the selected intention frame; and allocating the determined semantic role values to the semantic role elements included in the selected intention frame.

The method may further include that the allocating of the semantic role values comprises: determining whether at least one semantic role element of the sentence determined to be valid matches at least one semantic role element in the selected intention frame; and in response to it being determined that the at least one semantic role element of the sentence determined to be valid matches the at least one semantic role element in the selected intention frame: determining the semantic role values from the sentence determined to be valid through phrase chunking; and allocating the determined semantic role values.

The method may further include that, in response to the semantic role element of the sentence determined to be valid not matching the semantic role element in the selected intention frame, the allocating of the semantic role values further comprises: determining whether the sentence determined to be valid comprises a semantic role element other than the semantic role elements of the intention frame; in response to the sentence determined to be valid comprising a semantic role element other than the semantic role elements of the intention frame, determining whether the other semantic role element can be replaced by the semantic role element in the intention frame using a role network; and in response to it being determined that the other semantic role element can be replaced by the semantic role element in the intention frame: determining the semantic role value of the semantic role element in the intention frame from the sentence determined to be valid through phrase chunking; and allocating the determined semantic role value to the semantic role element in the intention frame.

The method may further include estimating the semantic role value of the at least one semantic role element in the intention frame using an ontology.

The method may further include: calculating probabilities that intention analysis has been correctly performed on at least one intention analysis result candidate to which the semantic role value of the semantic role element in the selected intention frame is allocated; and scoring the intention analysis result candidates.

The method may further include applying the intention analysis result to an application and generating an intention analysis application result.

The method may further include performing speech recognition on an audio input and converting the audio input into at least one sentence, the at least one sentence comprising an n-best sentence converted through the speech recognition.

In another general aspect, there is provided a computer-readable storage medium storing a program that causes a computer to execute a method of analyzing an intention, comprising: performing phrase spotting on at least one sentence by applying a context-free grammar to the at least one sentence in units of words or phrases; determining whether the at least one sentence is grammatically valid by: applying a dependency grammar to the sentence that has undergone phrase spotting; and filtering an invalid sentence; and generating an intention analysis result of a sentence determined to be valid.

Other features and aspects may be apparent from the following description, the drawings, and the claims.

### BRIEF DESCRIPTION OF THE DRAWINGS

FIG. 1 is a diagram illustrating an example of an apparatus for analyzing an intention.

FIG. 2 is a diagram illustrating an example of an intention analyzer.

FIG. 3 is a diagram illustrating an example of an intention deducer.

FIG. 4 is a flowchart illustrating an example of a method of a semantic role value allocator.

FIG. 5 is a diagram illustrating an example of context-free grammar.

FIG. 6 is a diagram illustrating an example of phrase spotting.

FIG. 7 is a diagram illustrating an example of a phrase spotting operation.

FIG. 8 is a diagram illustrating an example of dependency grammar.

FIG. 9 is a diagram illustrating an example of a role network.

FIG. 10 is a diagram illustrating an example of the allocation of a semantic role value in response to semantic role elements matching.

FIG. 11 is a diagram illustrating an example of the allocation of a semantic role value in response to semantic role elements not matching.

FIG. 12 is a diagram illustrating an example of the estimation of a semantic role value through phrase chunking.

FIG. 13 is a flowchart illustrating an example of a method for analyzing intention.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

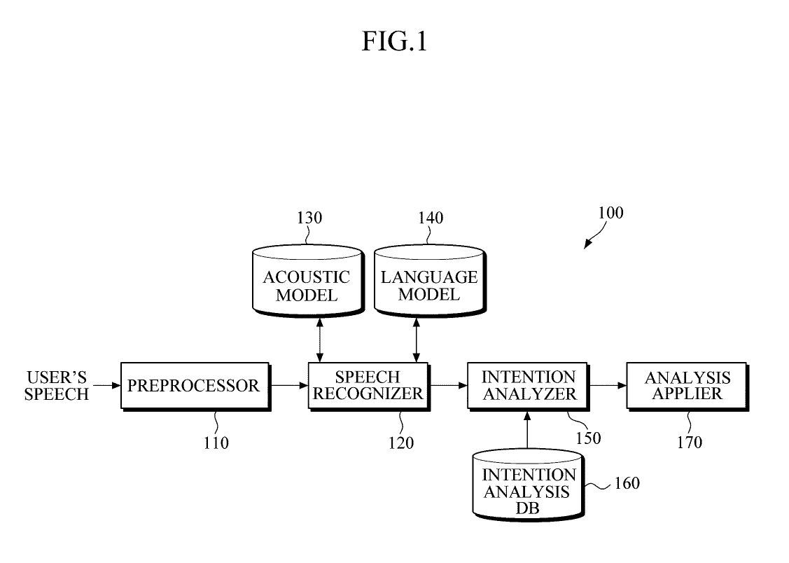

FIG. 1 illustrates an example of an apparatus for analyzing an intention.

FIG. 1 illustrates an example of an apparatus for analyzing an intention implemented in a speech dialogue system that performs speech recognition in response to a user's speech being input and analyzes the intentions of speech.

In this example, apparatus 100 for analyzing an intention includes a preprocessor 110, a speech recognizer 120, an acoustic model 130, a language model 140, an intention analyzer 150, an intention analysis database (DB) 160, and an analysis applier 170.

The preprocessor 110 detects a speech section from an input acoustic signal, generates speech feature information from the detected speech section, and transfers the speech feature information to the speech recognizer 120.

The speech recognizer 120 converts the input speech feature information into at least one speech recognition candidate sentence using at least one of the acoustic model 130 and the language model 140. The speech recognizer 120 may perform speech recognition alone or using both an acoustic feature and a language model. For example, a statistical language model such as an n-gram model or a grammar-based model such as a context-free grammar may be used as the language model 140. The speech recognizer 120 transfers a set of speech recognition candidate sentences. The speech recognition candidate sentences may be expressed by n-best sentences as speech recognition results to the intention analyzer 150. Each sentence output from the speech recognizer 120 may include tag information that indicates features of morphemes in the sentence.

When the speech recognizer 120 performs speech recognition using the acoustic model 130 or a statistical language model of the language model 140, the overall sentence structure and the meaning may not be taken into consideration. Also, when a frequently used n-gram model for speech recognition is applied, an ungrammatical sentence may be output as a speech recognition result. The intention analyzer 150 may solve these problems and may analyze the intention of a speech pattern, which has not been defined in advance and which may be referred to as an out-of-grammar (OOG) expression.

The intention analyzer 150 analyzes the intentions of the speech recognition candidate sentences generated by the speech recognizer 120, and generates and outputs speech recognition result candidates to which the intentions of the sentences are attached. Also, the intention analyzer 150 may verify the speech recognition result candidates, score the verified speech recognition result candidates, and rearrange the speech recognition result candidates based on the respective scores. For example, the intention analyzer may arrange the speech recognition results in a decreasing order based on score.

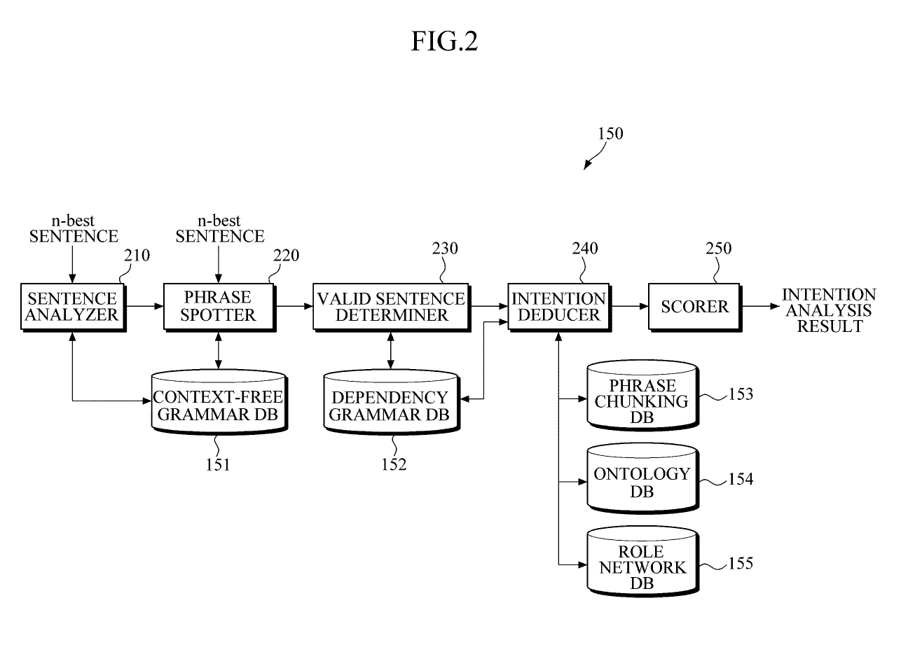

The intention analyzer 150 may analyze the intention of a recognized speech, for example, using context-free grammar, dependency grammar, and the like. When the context-free grammar is applied to a sentence, semantic roles may be attached to words or phrases of the sentence, and an intention analyzed from the whole sentence may be determined. The intention analysis DB 160 stores various information used for intention analysis. The intention analyzer is further described with reference to FIG. 2.

The analysis applier 170 may conduct a predetermined action based on an analyzed intention. The analysis applier 170 may execute a predetermined application according to the analyzed intention, and generate and provide the application execution results to a user. The analyzed intention may be varied according to a field to which speech recognition is applied, such as ticket reservation, performance reservation, and broadcast recording, and the like.

FIG. 2 illustrates an example of an intention analyzer. For example, the intention analyzer may be the intention analyzer 150 of the apparatus 100 of FIG. 1.

Referring to FIG. 2, the intention analyzer 150 includes a sentence analyzer 210, a phrase spotter 220, a valid sentence determiner 230, an intention deducer 240, a scorer 250, a context-free grammar DB 151, a dependency grammar DB 152, a phrase chunking DB 153, an ontology DB 154, and a role network DB 155. The context-free grammar DB 151, the dependency grammar DB 152, the phrase chunking DB 153, the ontology DB 154, and the role network DB 155 may be included in the intention analysis DB 160 of FIG. 1.

The sentence analyzer 210 may apply information stored in the context-free grammar DB 151 to at least one sentence generated by a user's speech, to analyze the intention of each sentence. When phrase spotting is performed on all input sentences, the sentence analyzer 210 may not be included in the intention analyzer 150. When intention analysis is successful, the results of successful intention analysis may be stored, and the intention of a next recognition candidate sentence may be analyzed using the context-free grammar. A speech recognition candidate sentence whose intention has been successfully analyzed and the intention analysis results may be transferred to the scorer 250.

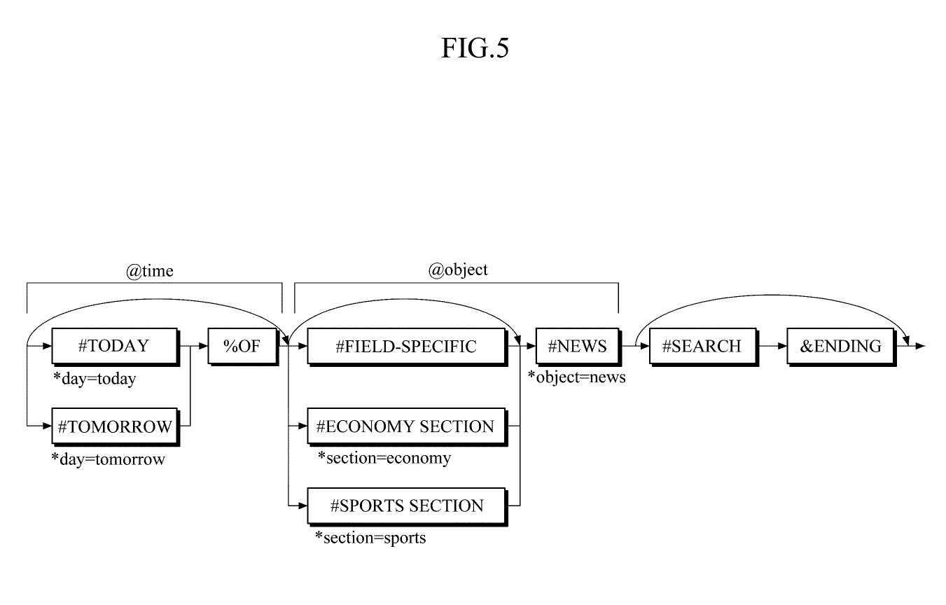

FIG. 5 illustrates an example of context-free grammar.

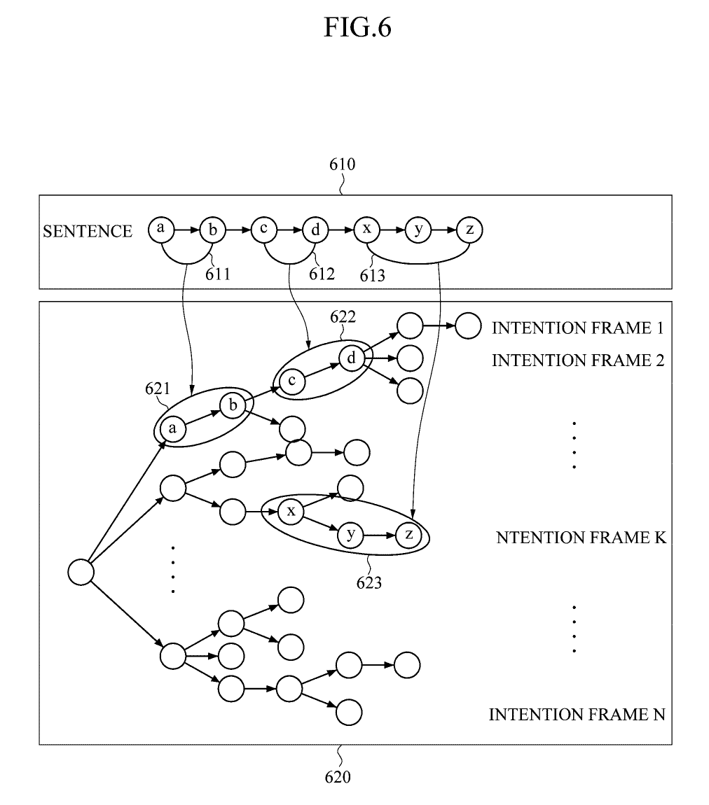

Context-free grammar information stored in the context-free grammar DB 151 may include information on the semantic role of each word or phrase and grammatical relationships between words or phrases. By applying the context-free grammar to a sentence, it is possible to determine whether the sentence is in an intention frame that is defined in the context-free grammar. The context-free grammar DB 151 may be expressed by a context-free grammar network 620 as shown in FIG. 6.

The intention frame refers to a format representing the intention of a user that may be obtained by applying the context-free grammar to a sentence. An intention frame may include an intention name and at least one semantic role element that are included in the intention frame. However, in cases, the intention frame may not include any semantic role. For example, a sentence “Turn TV on” has “Turn on TV” as an intention frame and has no semantic role element. At least one intention frame may be defined in advance for various fields, for example, a newspaper article search, a ticket reservation, a weather search, and the like.

FIG. 5 illustrates an example of information stored in the context-free grammar DB 151 about the field of a news search. For example, in response to “search(@object, @day, @section)” being determined as the intention frame of newspaper article search, the sentence spoken by the user may be determined to have an intention name “search” and indicate an order to search for articles about an object (@object) in a section (@section) from a day (@day) of the week.

In response to a speech recognition candidate sentence corresponding to an intention frame defined by the context-free grammar, and the sentence being analyzed using the context-free grammar, the sentence analyzer 210 may produce the analysis results as intention analysis results.

Meanwhile, a speech recognition candidate sentence whose overall intention is not analyzed using the context-free grammar is transferred to the phrase spotter 220 and undergoes semantic phrase spotting. Phrase spotting refers to semantic phrase spotting. For example, when a sentence is not analyzed using the context-free grammar due to an OOG expression included in a user's speech or a speech recognition error, the phrase spotter 220 may be used. The phrase spotter 220 applies the context-free grammar to each word or combination of words rather than the whole sentence. For example, when a sentence undergoes phrase spotting, results of partial phrase spotting, that is, the semantic roles of respective words or phrases, and at least one intention frame to which the semantic role of each word or phrase belongs may be determined in units. For example, the partial phrase spotting may determine an intention frame based on a word or a phrase from the sentence.

The purpose of phrase spotting is to perform an intention analysis of a sentence including an OOG expression. When intention analysis is performed using the context-free grammar alone, like conventional intention analysis algorithms, only sentences suited for the context-free grammar may be analyzed, and it may be difficult to analyze the intentions of a user's general speeches that are sometimes ungrammatical or not recognized.

FIG. 6 illustrates an example of phrase spotting.

Phrase spotting results are obtained only from interpretable words or phrases in a whole sentence. The phrase spotter 220 matches a speech recognition candidate sentence with nodes of a context-free grammar network using a grammar made according to the context-free grammar.

When an input sentence and the context-free grammar network are matched together, for example, a dynamic programming technique may be used. A matching level between the sentence and nodes of the context-free grammar network may be determined in units of words, phrases, and the like. Each phrase in one sentence may be interpreted to have various semantic roles, and one phrase may overlap and belong to several intention frames. Thus, one sentence may have several phrase spotting results.

Referring to FIG. 6, phrase spotting is performed on a sentence 610 consisting of \textcircled{a}-\textcircled{b}-\textcircled{c}-\textcircled{d}-\textcircled{x}-\textcircled{y}-\textcircled{z} with reference to the context-free grammar network 620. In this example, respective nodes \textcircled{a}, \textcircled{b}, \textcircled{c}, \textcircled{d}, \textcircled{x}, \textcircled{y}, and \textcircled{z} of the context-free grammar network 620 denote words of a sentence. The context-free grammar network 620 may be a context-free grammar expressed as a network of semantic roles.

Semantic roles, for example, a day of the week (@day), an object (@object), a section (@section), and a time (@time), indicate semantic roles of words in a sentence. In the context-free grammar network 620, arrows indicate that origination nodes of the arrows appear prior to destination nodes of the arrows in the sentence. In the context-free grammar network 620, sets of nodes connected by arrows may be defined as intention frames. Just as the semantic role of @time is mapped to example words “today” and “tomorrow” in FIG. 5, several example words may be mapped onto one semantic role in the context-free grammar network 620.

As shown in FIG. 6, the intention of the sentence 610 is not analyzed using the context-free grammar. When phrase spotting is performed on the sentence 610, \textcircled{a}-\textcircled{b}-\textcircled{c}-\textcircled{d}-\textcircled{x}-\textcircled{y}-\textcircled{z} may be determined to correspond to node paths 621, 622 and 623 in the context-free grammar network 620. In this example, an intention frame 1 and intention frame k may be determined as candidate intention frames of the sentence 610.

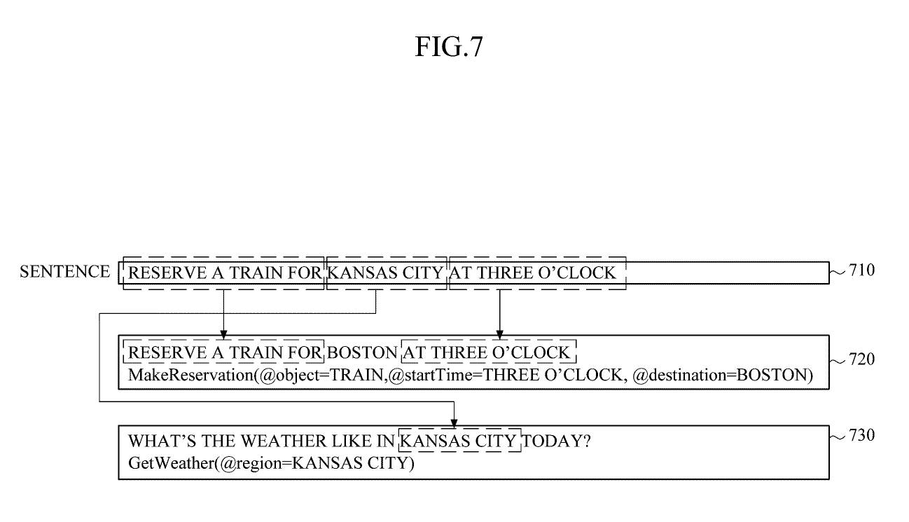

FIG. 7 illustrates an example of a phrase spotting operation.

When a speech recognition candidate sentence output recognized by the speech recognizer 120 is “Reserve a train for Kansas City at three o'clock,” it may be presumed that “reserve a train (@object) for Kansas City (@region) at three o'clock (@startTime)” is output from the context-free grammar network 620 as a result of applying the context-free grammar. Accordingly, one or more candidate intention analysis results may be determined as phrase spotting results.

Referring to FIG. 7, an intention frame MakeReservation(@object, @startTime, @destination) 720 and an intention frame Getweather(@region) 730 match the speech recognition candidate sentence in a high matching level of semantic roles. In FIG. 7, “MakeReservation(@object=train, @startTime=three o'clock, @destination=Boston),” “Reserve a train for Boston at three o'clock,” “GetWeather(@region=Kansas City),” and “What's the weather like in Kansas City?” indicate example word information and example sentences about respective intention frames in the context-free grammar network 620.

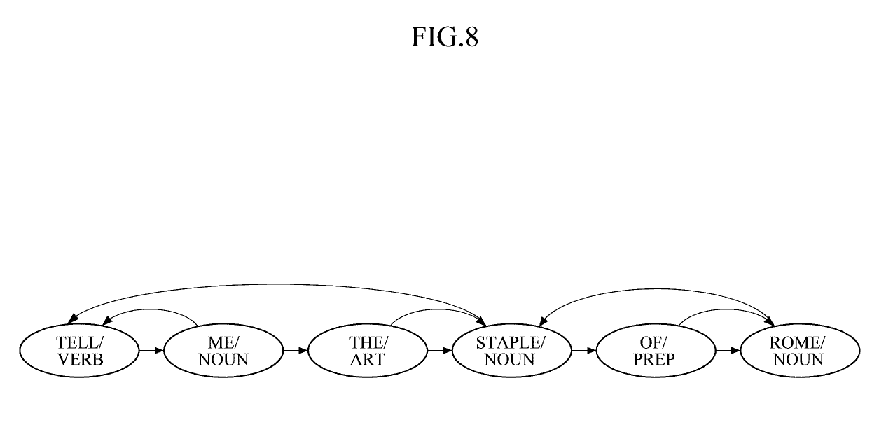

Referring back to FIG. 2, sentences that have undergone phrase spotting by the phrase spotter 220 are input to the valid sentence determiner 230. The valid sentence determiner 230 examines the grammatical and semantic validity of a sentence using the dependency grammar. The dependency grammar may be in a form as shown in FIG. 8. In FIG. 8, PV, NP, NC, NC, JCM, and NR refer to morpheme class tag information, each of which indicates a type of morpheme. The dependency grammar indicates what type of dependency relation is established between respective parts (words or phrases) of a sentence.

The valid sentence determiner 230 may examine dependency relations between respective parts of a sentence. Also, the valid sentence determiner 230 may examine whether respective phrases having semantic roles and respective phrases not having semantic roles are dependent upon each other. For example, word classes, words, meanings, and the like may be used as elements of the dependency grammar, and one or more of them may be used.

A sentence that has undergone phrase spotting and that has been determined to be valid according to the dependency grammar may be temporarily stored in a predetermined storage space where it may undergo an intention deduction process by the intention deducer 240. A sentence that has been determined to be invalid according to the dependency grammar is an ungrammatical sentence or a semantically incorrect sentence and may be filtered. In other words, among speech recognition candidate sentences that have undergone phrase spotting, an ungrammatical or semantically incorrect sentence may be ignored.

The intention deducer 240 determines one final intention frame among one or more intention frames that may be selected for a sentence that has undergone phrase spotting and been determined to be valid among speech recognition candidate sentences. In addition, the intention deducer 240 allocates semantic role values to semantic role elements which are components of the intention frame, and generates intention analysis results. The intention deducer 240 may estimate the semantic role values by applying an ontology such as WORDNET® to words that are not in the intention frame. Also, using a role network, the intention deducer 240 may deduce whether the words that are not in the intention frame correspond to semantic roles of the intention frame, and what kinds of semantic roles correspond to the words of the intention frame. Like WORDNET®, the ontology denotes semantic relationships between words, and the role network denotes relationship between semantic roles.

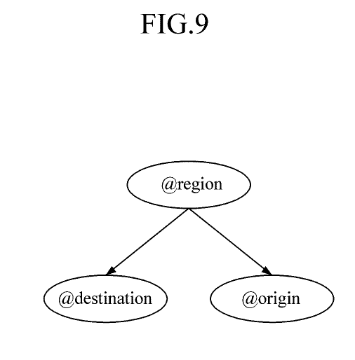

FIG. 9 illustrates an example of a role network.

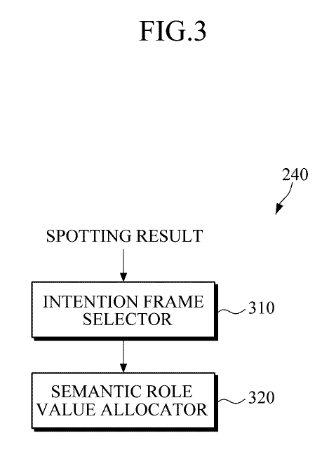

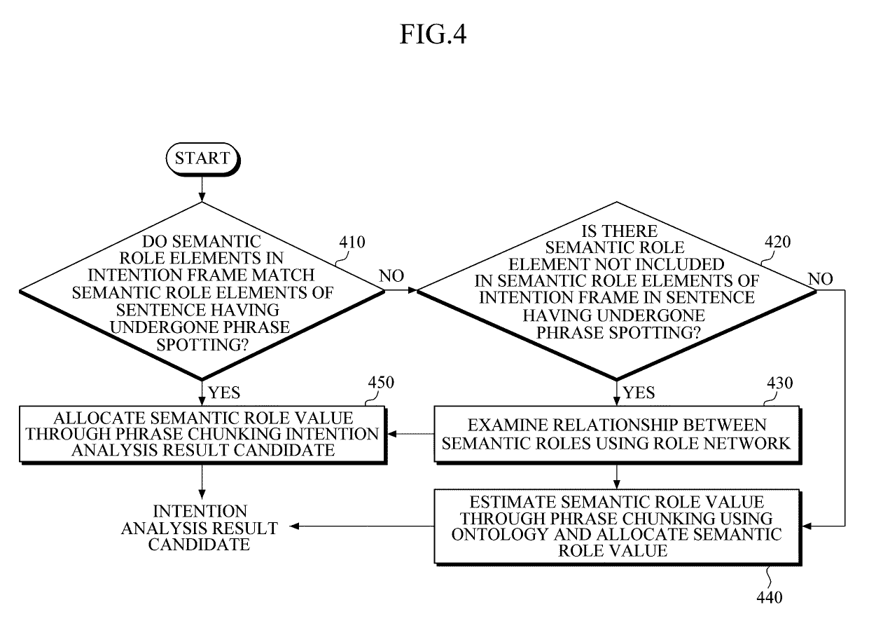

As shown in FIG. 9, @region denotes the semantic role of a region, @destination denotes the semantic role of a destination, and @origin denotes the semantic role of a point of origin. In other words, @region, @destination, and @origin have different semantic roles. However, @destination and @origin are disposed at lower nodes of @region in the semantic role network and may have a semantic relationship with each other. The intention deducer 240 is described later with reference to FIGS. 3 and 4.

Referring back to FIG. 2, the scorer 250 may calculate the probability that intention analysis results are speech recognition results and/or the probability that intention analysis has been correctly performed for the intention analysis results, and perform scoring based on the calculated probability. In this example, one of the intention analysis results is generated by the sentence analyzer 210 using the context-free grammar. The other intention analysis result is processed by the phrase spotter 220, the valid sentence determiner 230, and the intention deducer 240 because its intention frame has not been determined by the sentence analyzer 210. The following elements may be used for scoring:

a confidence score calculated by the speech recognizer 120 using acoustic features;

an element related with phrase spotting, such as information about how many network paths words match the context-free grammar network;

elements used for intention frame selection, such as the matching level between words, the matching level between word categories, the matching level between semantic role elements, and the matching level between headwords; and

elements whereby it is possible to determine if a sentence interpreted according to the context-free grammar and/or a sentence having undergone phrase spotting is correct, such as a variety of contexts (the field of current conversation, a field of interest to a user, previous speeches, a previous system response, and the like.

After performing the scoring, the scorer 250 transfers at least one intention frame for each speech recognition candidate sentence to which a score has been given to the analysis applier 170.

In the description above, a recognition candidate sentence whose overall intention has not been analyzed by the sentence analyzer 210 may be processed by the phrase spotter 220, the valid sentence determiner 230, and the intention deducer 240. Also, the intentions of n-best sentences output from the speech recognizer 120 may be directly analyzed by the phrase spotter 220 without the sentence analyzer 210.

Analyzing the intention of a recognition candidate sentence that the sentence analyzer 210 cannot successfully analyze using the phrase spotter 220 may be useful when a probability of an OOG expression occurring is low and it is desirable to use a small amount of resources. It is unnecessary to perform phrase spotting in the method when the intention of a sentence can be analyzed using the context-free grammar, and thus program execution time and required resources are reduced.

Analyzing the respective intentions of all speech recognition candidate sentences by performing phrase spotting using the phrase spotter 220 without using the sentence analyzer 210 from the beginning may be useful when a probability of an OOG expression occurring is high and one unified intention analysis structure is needed. In this example, intention analysis may be performed using the context-free grammar DB 152 once, unlike a case in which the sentence analyzer 210 is used. However, when an OOG expression is not included in a sentence, time or resources may be wasted.

FIG. 3 illustrates an example of an intention deducer, for example, the intention deducer 240 of FIG. 2.

Referring to FIG. 3, the intention deducer 240 includes an intention frame selector 310 and a semantic role value allocator 320.

The intention frame selector 310 selects an intention frame that is an intention analysis result for each speech recognition candidate sentence. The intention frame selector 310 may compare intention frames of the context-free grammar with the phrase spotting result of a sentence that is determined to be valid.

Various elements may be compared, for example, whether or not headwords of sentences match each other, whether or not semantic role elements match each other, whether or not words match each other, and the like. For example, the headword of a sentence may be a word that is determined to have the largest number of dependency relation with other words.

When an intention frame is selected, the semantic role value allocator 320 may allocate a semantic role value to at least one semantic role element included in the selected intention frame.

FIG. 4 illustrates an example of a method of a semantic role value allocator, for example, the semantic role value allocator 320 of the intention deducer 240 of FIG. 3.

Referring to FIG. 3, in operation 410 the semantic role value allocator 320 determines whether at least one semantic role element in an intention frame selected by the intention frame selector 310 matches at least one semantic role element of a speech recognition candidate sentence that has undergone phrase spotting. As mentioned above, the speech recognition candidate sentence that has undergone phrase spotting is a sentence that has been determined to be grammatically valid.

In response to at least one semantic role element in the selected intention frame matching at least one semantic role element of a speech recognition candidate sentence that has undergone phrase spotting, in operation 450 the semantic role value allocator 320 may allocate phrases corresponding to respective semantic roles of the speech recognition candidate sentence that has undergone phrase spotting as the semantic role values of semantic role elements in the intention frame.

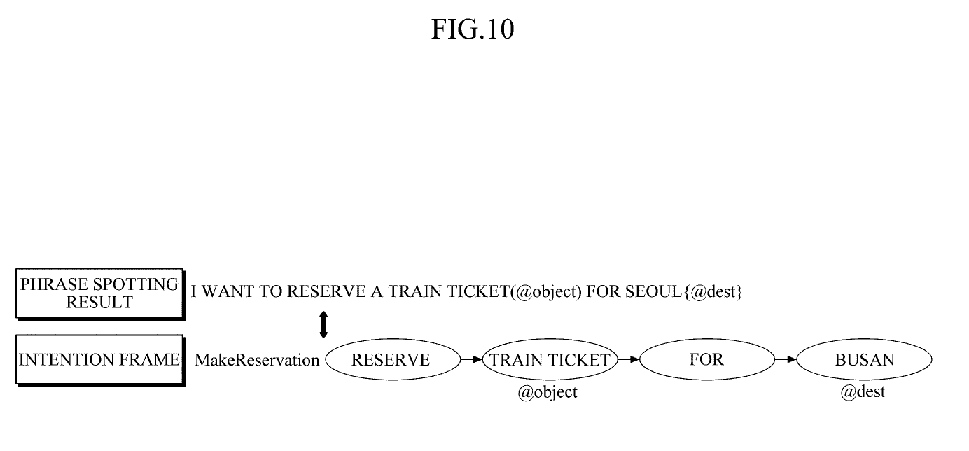

At this time, in response to words that do not match the semantic role elements of the intention frame being adjacent to a word corresponding to a semantic role in the speech recognition candidate sentence that has undergone phrase spotting, phrase chunking may be performed on the word together with the adjacent words using the phrase chunking DB 153 that stores information for phrase chunking to determine the range of the semantic role values. Phrase chunking refers to a natural language process that segments a sentence into sub-parts, for example, a noun, a verb, a prepositional phrase, and the like. When a semantic role value is allocated, at least one intention analysis result candidate may be generated. An example of this process is described with reference to FIG. 10.

FIG. 10 illustrates an example of the allocation of a semantic role value in response to semantic role elements matching.

Referring to the example shown in FIG. 10, a speech recognition candidate sentence that has undergone phrase spotting is “I want to reserve a train ticket (@object) for Seoul (@destination)” and a selected intention frame is “MakeReservation(@destination, @object),” Accordingly, semantic role elements of the speech recognition candidate sentence that has undergone phrase spotting match those in the selected intention frame, that is, @destination and @object. Thus, by allocating the semantic role values of the semantic role elements in the speech recognition candidate sentence to the corresponding semantic role elements of the intention frame, an intention analysis result “MakeReservation(@destination=Seoul, @object=train ticket)” may be generated.

Referring back to FIG. 4, in response to it being determined in operation 410 that at least one semantic role element in the selected intention frame does not match at least one semantic role element of a speech recognition candidate sentence that has undergone phrase spotting, in operation 420 the semantic role value allocator 320 determines whether a semantic role element that is not in the intention frame is in the sentence that has undergone phrase spotting.

In response to a semantic role element that is not in the intention frame being in the sentence that has undergone phrase spotting, in operation 430 the semantic role value allocator 320 may determine relationships between semantic roles with reference to a role network from the role network DB 155. In response to the semantic roles having a parent-child relationship in the role network, it may be determined that the semantic role is replaceable. In response to the semantic role being determined to be replaceable, in operation 450 the semantic role value allocator 320 may determine the range of a semantic role value through phrase chunking and allocate the semantic role value that belongs to the selected intention frame.

An example of this process is described with reference Such a case, in which a semantic role element of a speech recognition candidate sentence that has undergone phrase spotting using a role network can replace a semantic role element in an intention frame, may be useful when the number of semantic role elements of the speech recognition candidate sentence that has undergone phrase spotting match that of semantic role elements in the intention frame.

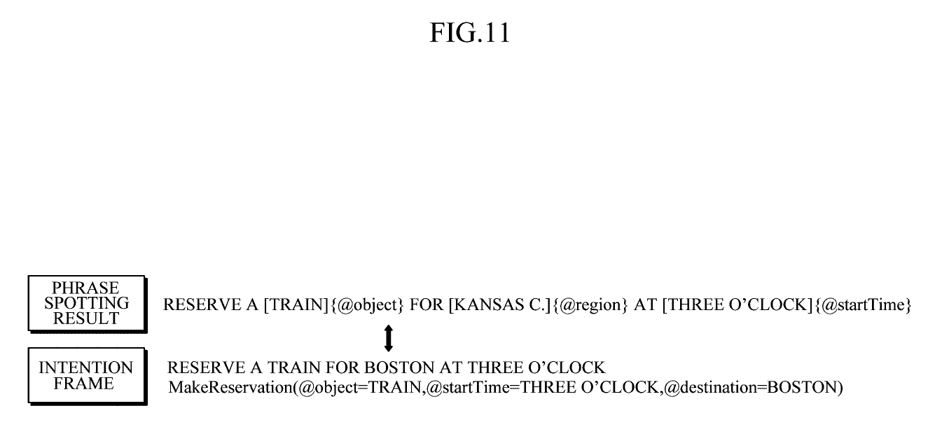

FIG. 11 illustrates an example of the allocation of a semantic role value in response to semantic role elements not matching.

When a phrase spotting result is “reserve a [train](@object) for [Kansas City](@region) at [three o'clock](@startTime),” and an intention frame is “MakeReservation(@object, @startTime, @destination),” the phrase spotting result has @region that is not in the intention frame. In this example, @region and @destination are in a parent-children relationship referring to a role network as shown in FIG. 9. Accordingly, @region and @destination may be replaced with each other. In response to the role values of the phrase spotting result being allocated to the corresponding semantic role elements of the intention frame, an intention analysis result “MakeReservation(@object=train, @startTime=three o'clock, @destination=Kansas City)” may be generated.

Referring back to FIG. 4, in response to it being determined in operation 420 that a semantic role element that is not in the intention frame is also not in the speech recognition candidate sentence that has undergone phrase spotting, in operation 440 the semantic role value allocator 320 may estimate a semantic role value through phrase chunking using the ontology and may allocate the semantic role value. The estimation of the semantic role value may be performed in response to it being determined that there is a semantic role element in the intention frame but not in the phrase spotting result.

For example, in operation 440 the semantic role value allocator 320 may check the positions of words that are not matching the intention frame in the phrase spotting result, and may determine the range of semantic role values through phrase chunking and allocate the semantic role values in response to it being determined that the words are at positions that may have semantic role values in the sentence.

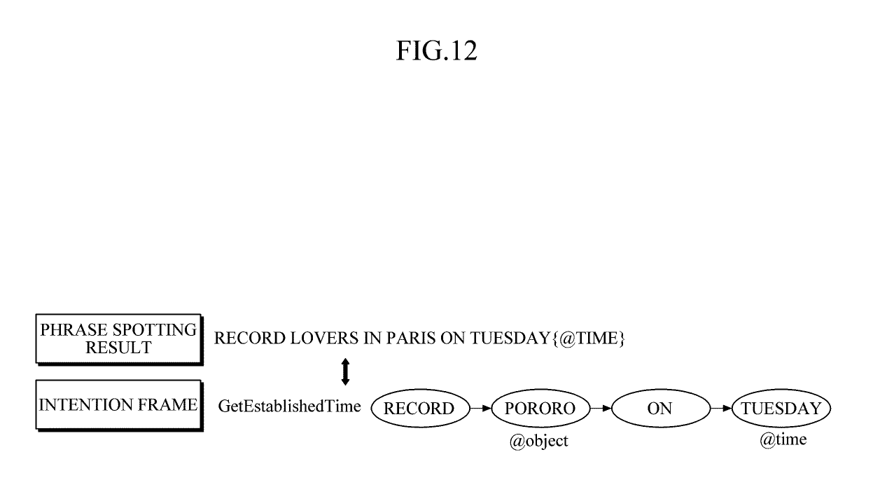

For example, the categories of words in the speech recognition candidate sentence that has undergone phrase spotting are compared with those of words corresponding to the semantic role elements of the intention frame. Semantic role values may be determined in response to the words in the speech recognition candidate sentence that has undergone phrase spotting and the words corresponding to the semantic role elements of the intention frame being in the same categories or in a parent-child relationship. Comparison of word categories may be performed using the ontology. Also, in response to a phrase being likely to be a proper noun, a semantic role value may be allocated without the category comparison process. An example of this process is described with reference to FIG. 12.

FIG. 12 illustrates an example of the estimation of a semantic role value through phrase chunking.

In response to a phrase spotting result being “Record Lovers in Paris on Tuesday (@time)” and a selected intention frame is “GetEstablishTime(@time, @object),” the semantic role of “Lovers in Paris” in the phrase spotting result may not be determined even with reference to an ontology. In this example, the semantic role value allocator 320 may determine “Lovers in Paris” as a proper noun and allocate “Lovers in Paris” to @object of the intention frame as a semantic role value. Thus, an intention analysis result “GetEstablishTime(@time=Tuesday, @object=Lovers in Paris)” may be generated.

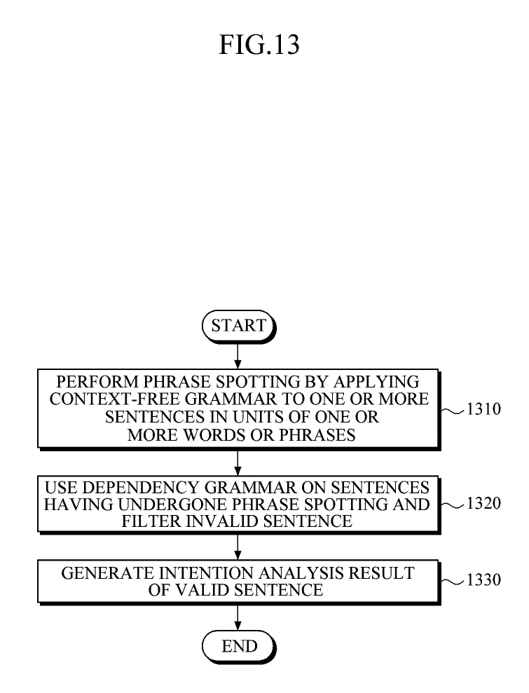

FIG. 13 illustrates an example of a method for analyzing intention.

In operation 1310, the phrase spotter 220 performs phrase spotting on at least one sentence by applying the context-free grammar to the at least one sentence.

In operation 1320, the valid sentence determiner 230 determines whether the sentences are grammatically valid by applying the dependency grammar to the sentences that have undergone phrase spotting, and filters an invalid sentence.

In operation 1330, the intention deducer 240 generates the intention analysis result of a sentence determined to be valid. For example, the intention deducer 240 may select an intention frame to be the intention analysis result of the sentence that has undergone phrase spotting, determine a semantic role value for a semantic role element included in the intention frame from the sentence that has undergone phrase spotting, and allocate the determined semantic role value to the semantic role element in the selected intention frame.

Thus far, an example in which the apparatus 100 for analyzing an intention is used in a speech dialogue system has been described. However, the apparatus 100 for analyzing an intention can be applied not only to sentences that are recognized by speech recognition but also to general sentences that are not recognized by speech recognition, and employed in systems having various forms for a variety of purposes.

For example, even when an OOG expression is included in a sentence generated in a user's speech the intention of the speech may be analyzed. Also, a sentence that has undergone speech recognition is grammatically or semantically verified while a speech recognition range is extended by generating the intention analysis result of the grammatically valid sentence. Accordingly, it is possible to prevent a sentence causing a speech recognition error from being output as a speech recognition result. During intention analysis, an OOG expression can be processed to increase the degree of freedom of speech of a user, and the rate of success in intention analysis and the overall performance of a speech dialogue system can be increased in comparison with a conventional speech dialogue system that performs speech recognition using predetermined speech only.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for analyzing intention, the apparatus comprising:
a phrase spotter configured to perform phrase spotting on at least one sentence by applying a context-free grammar to the at least one sentence in units of words or phrases;
a valid sentence determiner configured to:
determine whether the at least one sentence is grammatically valid by applying a dependency grammar to the sentence that has undergone phrase spotting; and
filter an invalid sentence; and
an intention deducer configured to generate an intention analysis result of a sentence determined to be valid.

2. The apparatus of claim 1, wherein the intention deducer is further configured to:
select an intention frame to be the intention analysis result of the sentence determined to be valid;
determine a semantic role value of at least one semantic role element included in the selected intention frame; and
allocate the determined semantic role value to the semantic role element included in the selected intention frame.

3. The apparatus of claim 2, wherein, in response to the intention deducer allocating the semantic role value, the intention deducer is further configured to:
determine the semantic role value from the sentence determined to be valid through phrase chunking; and
allocate the determined semantic role value to the semantic role element in the selected intention frame if at least one semantic role element of the sentence determined to be valid matches at least one semantic role element in the selected intention frame.

4. The apparatus of claim 3, wherein, in response to the sentence determined to be valid comprising a semantic role element other than the at least one semantic role element in the intention frame, the intention deducer is further configured to:
determine whether the other semantic intention role element can be replaced by the semantic role element in the intention frame using a role network;
determine a semantic role value of the semantic role element in the intention frame from the sentence determined to be valid through phrase chunking in response to it being determined that the other semantic intention role element can be replaced by the semantic role element in the intention frame; and
allocate the determined semantic role value to the semantic role element in the intention frame.

5. The apparatus of claim 3, wherein the intention deducer is further configured to estimate the semantic role value of the at least one semantic role element in the intention frame using an ontology.

6. The apparatus of claim 2, further comprising a scorer configured to:
calculate a probability that intention analysis has been correctly performed on at least one intention analysis result candidate to which the semantic role value of the semantic role element included in the selected intention frame is allocated; and
score the intention analysis result candidate.

7. The apparatus of claim 1, further comprising an analysis applier configured to:
apply the intention analysis result to an application; and
generate an intention analysis application result.

8. The apparatus of claim 1, further comprising a speech recognizer configured to convert an audio input into at least one sentence, the at least one sentence comprising an n-best sentence converted by the speech recognizer.

9. A method of analyzing an intention, the method comprising:
performing phrase spotting on at least one sentence by applying a context-free grammar to the at least one sentence in units of words or phrases;
determining whether the at least one sentence is grammatically valid by:
applying a dependency grammar to the sentence that has undergone phrase spotting; and
filtering an invalid sentence; and
generating an intention analysis result of a sentence determined to be valid.

10. The method of claim 9, wherein the generating of the intention analysis result of the sentence determined to be valid comprises:
selecting an intention frame to be the intention analysis result of the sentence determined to be valid;
determining semantic role values of semantic role elements included in the selected intention frame; and
allocating the determined semantic role values to the semantic role elements included in the selected intention frame.

11. The method of claim 10, wherein the allocating of the semantic role values comprises:
determining whether at least one semantic role element of the sentence determined to be valid matches at least one semantic role element in the selected intention frame; and
in response to it being determined that the at least one semantic role element of the sentence determined to be valid matches the at least one semantic role element in the selected intention frame:
determining the semantic role values from the sentence determined to be valid through phrase chunking; and
allocating the determined semantic role values.

12. The method of claim 11, wherein, in response to the semantic role element of the sentence determined to be valid not matching the semantic role element in the selected intention frame, the allocating of the semantic role values further comprises:
determining whether the sentence determined to be valid comprises a semantic role element other than the semantic role elements of the intention frame;
in response to the sentence determined to be valid comprising a semantic role element other than the semantic role elements of the intention frame, determining whether the other semantic role element can be replaced by the semantic role element in the intention frame using a role network; and
in response to it being determined that the other semantic role element can be replaced by the semantic role element in the intention frame:
determining the semantic role value of the semantic role element in the intention frame from the sentence determined to be valid through phrase chunking; and
allocating the determined semantic role value to the semantic role element in the intention frame.

13. The method of claim 11, further comprising estimating the semantic role value of the at least one semantic role element in the intention frame using an ontology.

14. The method of claim 10, further comprising:
calculating probabilities that intention analysis has been correctly performed on at least one intention analysis result candidate to which the semantic role value of the semantic role element in the selected intention frame is allocated; and
scoring the intention analysis result candidates.

15. The method of claim 9, further comprising applying the intention analysis result to an application and generating an intention analysis application result.

16. The method of claim 9, further comprising performing speech recognition on an audio input and converting the audio input into at least one sentence, the at least one sentence comprising an n-best sentence converted through the speech recognition.

17. A computer-readable storage medium storing a program that causes a computer to execute a method of analyzing an intention, comprising:
performing phrase spotting on at least one sentence by applying a context-free grammar to the at least one sentence in units of words or phrases;
determining whether the at least one sentence is grammatically valid by:
applying a dependency grammar to the sentence that has undergone phrase spotting; and
filtering an invalid sentence; and
generating an intention analysis result of a sentence determined to be valid.
